(19) United States
(12) Patent Application Publication
(10) Pub. No.: US 2012/0102646 A1
(43) Pub. Date: May 3, 2012

(54) Furniture Cover

(75) Inventors: Dellon Dai Chen, San Ramon, CA (US); Hua Jin, Belmont, CA (US)

(73) Assignee: STANDARD FIBER, LLC, South San Francisco, CA (US)

(21) Appl. No.: 13/019,125

(22) Filed: Feb. 1, 2011

(30) Foreign Application Priority Data
Oct. 29, 2010 (CN) 201020594649.8

(51) Int. Cl. A47G 9/00; D05B 3/00; A44B 18/00; B23P 11/00; A47C 31/00; A44B 19/26

(52) U.S. Cl. 5/499; 24/415; 29/428; 112/475.17

(57) ABSTRACT

A furniture cover is configured to encase furniture to prevent the egress of insects through the furniture cover. The furniture cover includes an aperture through which furniture may pass into the furniture cover. The aperture has a closure mechanism disposed along the edges and can be sealed by an operating mechanism operating on the closure mechanism. An operating mechanism cover seals an end of the closure mechanism by way of two fastening surfaces and a compressible insert.

### CROSS REFERENCE TO RELATED APPLICATIONS

This application claims priority to Chinese Patent Application No. 201020594649.8 filed on Oct. 29, 2010, which is hereby incorporated by reference.

### FIELD

The present application relates to bug-resistant covers for furniture. More particularly, this application relates to a zippered enclosure for receiving a piece of a furniture, the enclosure configured to prevent insects from escaping the enclosure. Embodiments of the furniture cover include those for a mattress.

### BACKGROUND

Bedbugs are small parasitic insects that commonly hide within mattresses or other furniture. Bedbugs live by feeding on the blood of warm-blooded animals. As such, bedbugs are a pest with numerous health effects attributable to their feeding on human blood. Bedbugs typically remain close to their host in a location such as a bed or couch, hiding most of the time, and coming out to feed.

Once infested, bedbugs can be difficult to remove. Insecticides may be used, however bedbugs are becoming increasingly resistant to the insecticide. In addition, many people resist using insecticides in their homes and/or bedding for several reasons. This is so because insecticides may be toxic to people and pets, thus their use requires people to temporarily leave their homes. In addition, insecticides may have harmful environmental effects, which further give some people pause.

Another common method of treating locations suffering from bedbugs is to apply a heat treatment. This involves heating the room/house and items within it to a quite elevated temperature. The elevated temperature kills bedbugs, but these temperatures are not tolerable for people or pets, thus they must temporarily leave during the heat treatment. The elevated temperatures also may cause heat stress, warping, and potentially other damage to the structure of the room/house and the belongings within them. These disadvantages, too, may cause people to eschew using heat to eradicate bedbugs.

One increasingly recommended method or eradicating a bedbug infestation is encasement. Bedbugs normally feed every five to ten days, but may live as long as a year between feedings. In encasement, the bedbugs are encased within their hiding spots and prevented from finding a food source. Eventually, the bedbugs will starve and the infestation will be eradicated.

In order for an encasement to be effective, it should prevent the bedbugs from escaping and feeding. Since bedbugs are small in size, typically on the order of 4-5 millimeters long and 1.5-3 millimeters wide as an adult, seams, holes, and similar discontinuities in the encasement create a potential egress route for the bedbug. One common egress route is a zipper used to seal the encasement. Individuals may fail to completely close the zipper leaving a small opening. Even when a zipper is closed completely, a small gap will typically exist at the end of the zipper. Such an egress route could allow the bedbugs to escape to feed and, consequently, to continue to propagate.

U.S. Pat. No. 7,553,489 to Bell addresses the need to prevent the escapement of bedbugs from a zipper opening in a mattress encasement. In Bell, a single foam pad is sewn inside the encasement system at the end of a zipper track on each side. The foam is sewn tightly to the encasement and when the encasement covers a mattress, the foam pad is pressed upward into the zipper in the closed position. As a result, a narrow path exists between the zipper and the foam. The height of the passage is typically small compared to the height of a bedbug, hindering the movement of the bedbug. If the bedbug is able to crawl through the passage, the foam and the zipper head form a barrier that the bug cannot pass.

Bell, however, has some shortcomings. First, the foam used can be relatively expensive, and Bell requires a relatively large foam pad. Second, securing the foam inside the mattress encasement can add to the complexity of its manufacture. Third, the foam pad immediately under the zipper can interfere with the closure of the zipper in some situations.

It would be beneficial to have an encasement system that minimized the use of the foam, was easy to manufacture, and did not interfere with the operation of the zipper.

### SUMMARY

Embodiments of the present invention include a bug-resistant encasement for furniture. The bug-resistant encasement includes a cover, an aperture, a sliding fastener assembly, fastening assembly, and a fastener cover.

The cover is sized and shaped to encase the furniture. The cover has an exterior surface and an interior surface, with the interior surface forming a space for receiving the furniture.

The aperture is formed in the cover and is sized and shaped to allow passage of the furniture through the aperture into the space for receiving the furniture. The aperture has a first edge and a second edge, that when joined, close the aperture.

The sliding fastener assembly is disposed near the aperture and has a closed end and an open end. The sliding fastener has a first track near the first edge and extends from the closed end to the open end and a second track near the second edge and extends from the closed end to the open end. A sliding fastener is disposed on the first and second track between the closed end and the open end. The sliding fastener mechanically joins the first track to the second track between the closed end and the sliding fastener.

The fastener cover is disposed near the open end of the sliding fastener assembly and has a second fastening surface. The second fastening surface has an insert that includes a compressible material. In some embodiments, the compressible material is made of foam such as polyethylene foam, polyurethane foam, and rubber foam.

In some embodiments, the sliding fastener is disposed at the closed end and the first fastening surface and the second fastening surface are fastened to each other, thereby positioning the fastening cover over the fastener. The sliding fastener is configured to compress the compressible material, thereby forming a seal between the compressible material and the sliding fastener.

In some embodiments, the fastening cover has a side fastened to the exterior surface of the cover, which is fastened perpendicular to the first track and the second track. In other embodiments, the encasement system has the fastening cover fastened to the exterior side parallel to the first track and the second track.

In some embodiments, the first fastening surface and the second fastening surface may be hook and loop type fasteners.

Embodiment are further directed to a bug-resistant, sliding fastener assembly for joining two edges of material. The embodiments include a first edge of material, a second edge of material, an operating mechanism, a closure mechanism, a first fastening surface, and a cover.

The operating mechanism includes an interior side and an exterior side, with the exterior side having a grip for manipulating the operating mechanism. The closure mechanism has a first side secured to the first edge and a second side secured to the second edge. The closure mechanism has a first end and a second end. The closure mechanism is configured to receive the operating mechanism and slidably engages the closure mechanism between a first end at which the first edge is coupled to the second edge and a second end at which the first edge is substantially decoupled from the second edge.

The cover is be secured to the material near the first fastening surface. The cover includes a second fastening surface configured to interlock with the first fastening surface. The second fastening surface includes an interior portion that has a compressible material for enveloping the exterior side of the sliding fastener. Embodiments of the compressible material include, but are not limited to, a flexible foam such as of polyethylene foam, polyurethane foam, and/or rubber foam. The second fastening surface at least partially surrounds the compressible material. Optionally, the cover includes a first cover edge secured to the fabric along the first edge perpendicular to the closure mechanism. Alternatively, the cover is secured along the first cover edge parallel to the closure mechanism.

Embodiment are also directed to a method for constructing a bug-resistant furniture encasement. A material having an interior sized and shaped to encase a piece of furniture may be fabricated, including an aperture sized and shaped to pass the piece of furniture into the interior. A fastening track is fastened to the material about the aperture, and a sliding fastener to may be fastened to the fastening track to selectively opens and closes the aperture. A first fastening surface proximate said aperture is secured to the material and a flap is secured to the material proximate the aperture. The flap has a second fastening surface and a compressible insert. The flap is positioned to cover the zipper with the compressible insert when the first fastening surface and the second fastening surface are joined when the sliding fastener closes the aperture.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

To further clarify the above and other advantages and features of the one or more present inventions, reference to specific embodiments thereof are illustrated in the appended drawings. The drawings depict only typical embodiments and are therefore not to be considered limiting. One or more embodiments will be described and explained with additional specificity and detail through the use of the accompanying drawings in which:

FIG. 1 is a perspective view of a mattress cover.

FIG. 2 is a perspective view of an embodiment of a bug-resistant mattress cover.

FIG. 3 is an orthogonal close up view of the fastener cover of the embodiment of FIG. 2.

FIG. 3a is an orthogonal close up view of the fastener cover of the embodiment of FIG. 2 with the fastener cover covering a zipper hear.

FIG. 3b is a cross sectional view AA of FIG. 3.

FIG. 3c is a cross sectional view of an alternative embodiment of FIG. 3.

FIG. 4 is an orthogonal close up view of the fastener cover of the embodiment of FIG. 3, with the zipper head in a different position.

FIG. 5 is an orthogonal view of another embodiment of a bug-resistant furniture cover.

FIG. 6 is a flowchart depicting an embodiment of a method for fabricating a bug-resistant furniture cover.

FIG. 7 is a flowchart depicting another embodiment of a method for fabricating a bug-resistant furniture cover.

The drawings are not necessarily to scale.

### DETAILED DESCRIPTION

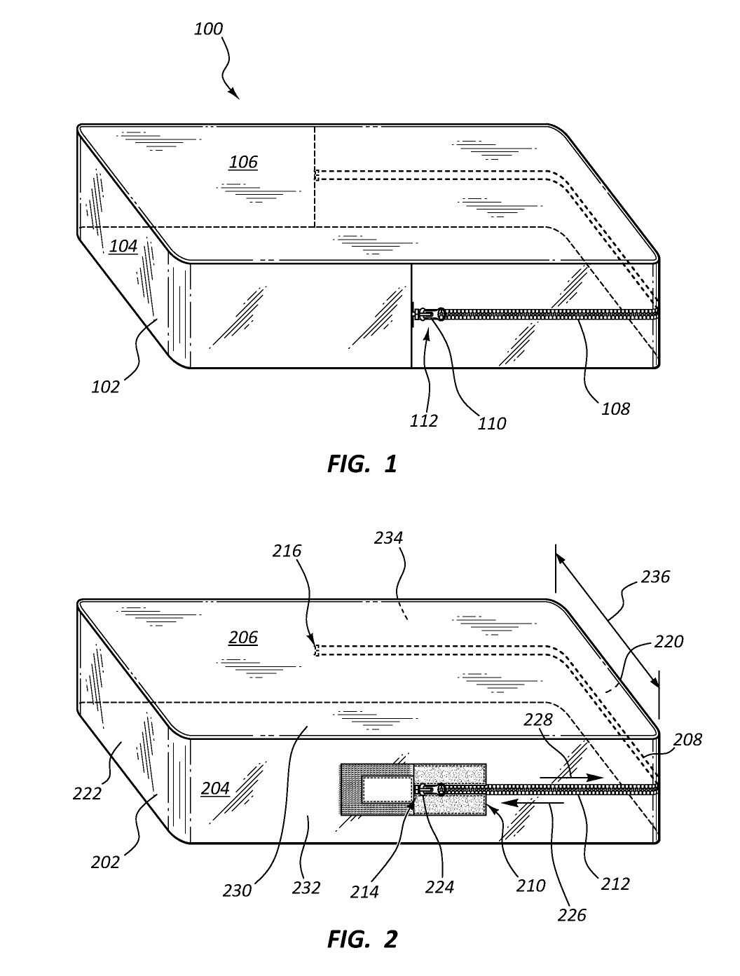

FIG. 1 illustrates a perspective view of a typical mattress cover 100. The mattress cover 100 has a cover 102 with an exterior surface 104 and an interior surface 106. The mattress cover has an aperture 108 through which a mattress is inserted. The aperture 108 has a zipper 110 that opens and closes the aperture 108. In use, the zipper 110 typically provides an egress route for bedbugs. In some instances, the zipper 110 may not be closed completely, leaving an space 112 at the end of the zipper 110. Even when the zipper is closed completely, the space 112 may still exist, leaving an egress route for bedbugs.

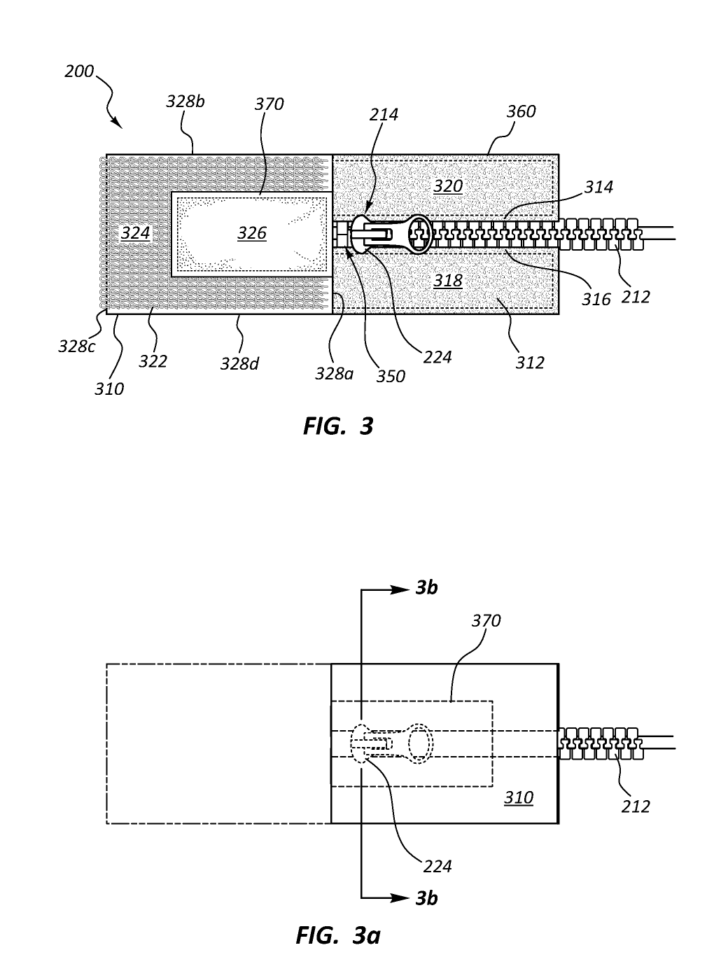

FIG. 2 illustrates a perspective view of an embodiment of a bug-resistant mattress cover 200. Although FIG. 2 is shown as a mattress cover, alternative embodiments are suitable for at least partially covering other types of furniture, such as couches and chairs, cushions, and the like.

The bug-resistant mattress cover 200 has a means for covering a mattress. In the embodiment of FIG. 2. the means is a cover 202 sized and shaped to cover a mattress. The cover 202 has an open end 220 and a closed end 222. The cover 202 has an exterior surface 204 and an interior surface 206. The interior surface 206 bounds an interior space 230 for receiving a mattress. Embodiments of the cover 202 include those made from fabric woven in such a way and made of a material such that it impermeable to bedbugs. For example, the cover 202 may be constructed of wool, cotton, linen, and other natural fabrics. In other embodiments, the cover 202 may be constructed of synthetic fabrics such as nylon, polyester, and the like. In other embodiments, the fabric may be a single sheet of material without any weaving, such as a sheet of plastic or other material.

The cover 202 has an aperture 208 sized and shaped for a mattress to be inserted. The aperture 208 is located at a first side 220 of the cover 202. In other embodiments, the aperture 208 is located at other locations of the cover 202. The aperture 208 starts midway along a second side 232 of the cover 202 and extends to the first side 220, across a width 236 of the first side 220, and continue midway along a third side 234 of the cover 202. In other embodiments, the starting point of the aperture 208 may not be located midway along the second side 232 of the cover 202 but may be greater or less than midway. In some embodiments, the aperture 208 may be located entirely on the first side 220 of the cover 202. Other aperture locations are contemplated, provided that the aperture 208 location allows a mattress to pass into the interior space.

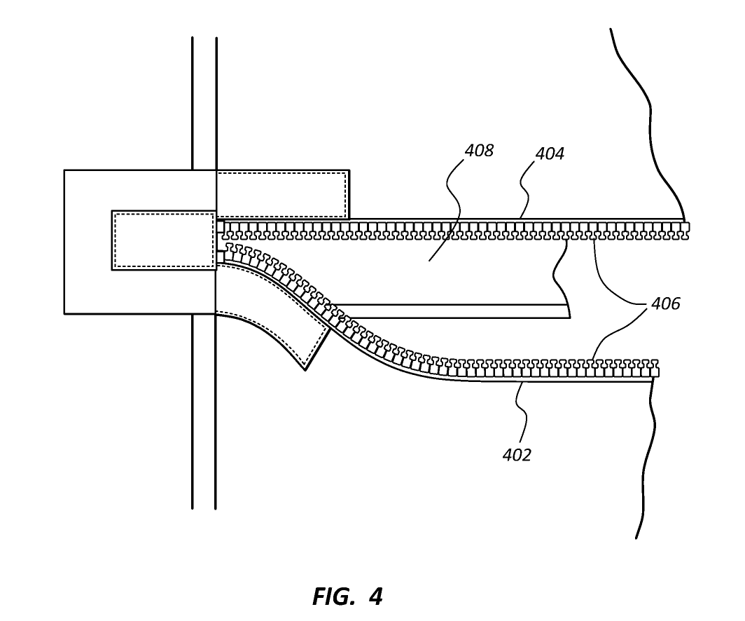

The cover 200 has a means for closing the aperture 208. Examples of such means include sliding fastener assemblies such as zipper assemblies, plastic slide assemblies and the like. In the embodiment of FIG. 2, the means is a zipper assembly 210 that selectively opens and closes the aperture 208. The zipper assembly 210 includes a zipper track 212 and a zipper head 224. The zipper track 212 has a pair of zipper sides 402, 404 as shown in FIG. 4. The zipper sides 402, 404 have interlocking teeth 406 that, when interlocked, secure the zipper sides 402, 404 together. The interlocking teeth 406 are sized and shaped to fit snugly to one another when the zipper is closed, thereby preventing bedbugs from traveling around the interlocking teeth 406 and, consequently, passing from the interior space 230 to the exterior of the cover 202. The zipper sides 402, 404 are each attached to the cover 202 proximate the aperture 208. The zipper sides 402, 404 are attached to the cover 202 by stitching, sewing, adhesive, seamless bonding, such as welding of various types (e.g., heat welding and ultrasonic welding) and other fastening methods.

The zipper head 224 travels along the zipper track 212 from a first end 214 to a second end 216. The zipper head 224 may travel in a closing direction 226 in which the zipper head 224 couples the zipper sides 402, 404 thereby closing the aperture 208, or an open direction 228 in which the zipper head 224 decouples the zipper sides 402, 404 thereby opening the aperture 208. Generally, as the zipper head 224 travels towards the second end 216 of the zipper track 212, the zipper head 224 is traveling in the open direction 228. As the zipper head 224 travels towards the first end 214 of the zipper track 212 it is traveling in the closing direction 226.

When the zipper head 224 is positioned at the second end 216 of the zipper track 212, the zipper sides 402, 404 are substantially decoupled and may be coupled only at the second end 216. In other embodiments, the zipper sides 402, 404 completely separate from one another when the zipper head 224 is positioned at the second end 216. With the zipper sides 402, 404 being decoupled, the interior space 230 is accessible through the open aperture 208.

In operation, the zipper head 224 is slid along the zipper track 212 in the opening direction 228 towards the second end 216 of the zipper track 212 thereby opening the aperture 208. A mattress is then inserted within the cover 202, after which the zipper head 224 is slid in the closing direction 226 towards the first end 214 of the zipper track 212. When the zipper head 224 reaches the first end 214, the zipper sides 402, 404 are coupled and the aperture 208 is closed. The mattress is then encased within the cover 202. To remove the mattress, the zipper head 224 is slid along the zipper track in the opening direction 228 towards the second end 216 of the zipper track 216, thereby decoupling the zipper sides 402, 404 from one another and opening the aperture 208. The mattress may then be removed from the cover 202 through the aperture 208.

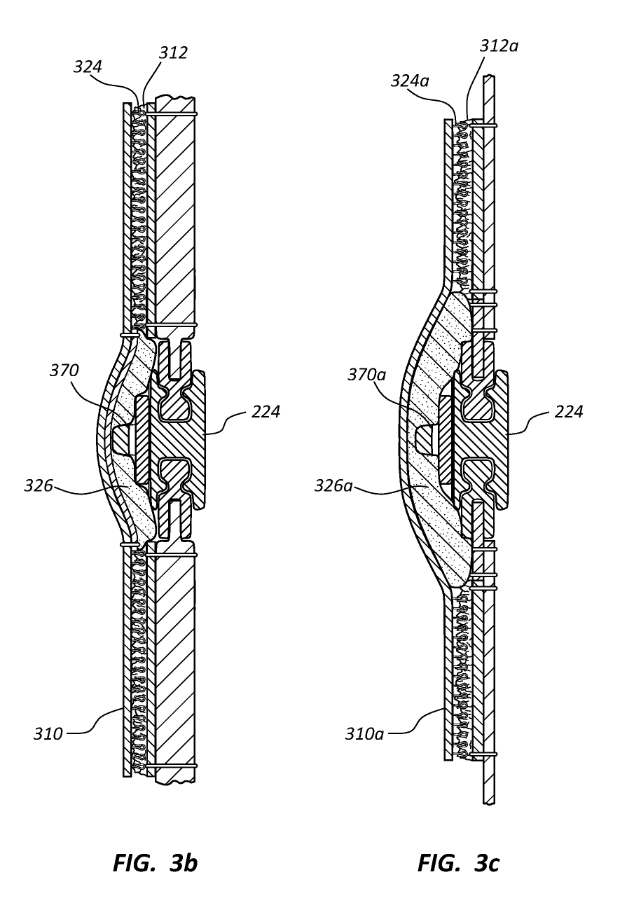

FIG. 3 illustrates a close up view of the zipper cover 310 portion of FIG. 2. The operation of the zipper cover 310 will be described with respect to the close up view of FIG. 3.

As previously described, the aperture 208 of the cover 202 may be closed by sliding the zipper head 224 along the zipper track 212 from the second end 216 to the first end 214. The zipper head 224 couples the two zipper sides 402, 404 as the zipper head 224 passes resulting in an coupled zipper portion between the second end 216 and the zipper head 224. When the zipper head 224 travels to the first end 214, the zipper sides 402, 404 are coupled, thereby closing the aperture 208. Even with that aperture 208 closed, the bug-resistant mattress cover 200 could have routes through which bedbugs might escape from the interior space 230. As can be seen in FIG. 3, a small space 350 may exist between the zipper head 222 and first end 214 of the zipper track 212.

The bug-resistant mattress cover 200 includes a means for sealing the small space 350 at the first end of the zipper track 212. In the embodiment of FIG. 3, the means is a zipper cover 310. The zipper cover includes a fastening means for fastening the zipper cover to cover 202. Examples of fastening means includes hook and loop fasteners, snaps, buttons and the like. In the embodiment of FIG. 3 a first fastening surface 312 is disposed proximate the first end of the zipper track 212. The first fastening surface 312 is be stitched to the exterior surface 204 of the cover 202 with stitching 360. Other means of attaching the first fastening surface 312 to the cover 202 are possible, such as an adhesive, or in some embodiments the first fastening surface 312 may be integral to the exterior surface 204. The first fastening surface 312 provides a fastening surface surrounding at least each lateral side 314, 316 of the first end 214 of the zipper track 212. In some embodiments, the first fastening surface 312 has two individual surfaces 318, 320, each disposed on a lateral side 314, 316 of the zipper track 212. In other embodiments, the first fastening surface 312 extends past the first end 214 of the zipper track 212 to form a U-shaped fastening surface with the open end 214 of the zipper track 212 disposed within the open portion of the U (not shown).

The zipper cover 310 is attached proximate the first end 214 of the zipper track 212. The zipper cover 310 is a substantially flat surface having the shape of a square with four edges 328a, 328b, 328c, 328d. The zipper cover 310 may have a first side 360 made of a material that is complementary to the covering 202. A second side 322 of the zipper cover 350 has a second fastening surface 324 that interfaces with the first fastening surface 312. The second fastening surface 324 is complementary to the first fastening surface 312, having a shape mirroring the shape of the first fastening surface 312. In other embodiments, the second fastening surface 324 has a shape that is different than the shape of the first fastening surface 312.

The second side 322 of the zipper cover 310 has an insert 326 formed of a compressible material, such as an elastomeric material or foam. The insert 326 may be stitched to the second side 322 of the zipper cover 310 with stitching 370. In other embodiments, the insert may be secured by adhesive, seamless bonding, such as welding of various types (e.g., heat welding and ultrasonic welding) and other fastening methods. The material may be elastically deformable. In some embodiments, the material has a durometer of less than 55 A. In some embodiments, the insert 326 is surrounded by the second fastening surface 324. In other embodiments, the insert 326 expands to an edge 328a of the zipper cover 310.

The zipper cover 310 is attached at the first edge 328a proximate the first end 214 of the zipper track 212. The zipper cover 310 is sewn, stitched, glued, or attached by any other suitable means to the exterior surface 204. In some embodiments, the zipper cover 310 is made of a piece of fabric integral with the first fastening surface 312. The zipper cover 310 is able to rotate about the first edge 328a. In some embodiments, the first edge 328a is perpendicular to the zipper track 212 proximate the first end 214, or in other embodiments the first edge 328 is be parallel to the zipper track 212 proximate the first end 214. In still other embodiments, the first edge 328a may be at an angle to the zipper track 212 proximate the first end 214.

FIG. 3a shows the zipper cover 310 positioned over the first end 214 of the zipper track 212. The zipper head 224 is shown as an outline underneath the zipper cover 310. The outline of the insert 326 is visible by the stitching 370. The second fastening surface 324 of the zipper cover 310 is fastened to the first fastening surface 312 securing the zipper cover 310 over the zipper head 224.

FIG. 3b is a cross-sectional view of the zipper cover 310 in place over the zipper head 224. The first fastening surface 312 is fastened to the second fastening surface 324. The insert 326 is pressed against the zipper head 224. The compressible material of the insert 326 compresses, enveloping the outer surface 390 of the zipper head 224. This effectively holds the zipper head 224 in place at the first end 214. In addition, the compressible material of the insert 326 effectively seals the zipper cover 310 to the zipper head 224. With the zipper cover 310 sealed to the zipper head 224, the small space 350 is substantially sealed, reducing the risk of and, preferably, preventing, any insects from passing through the first end.

FIG. 3c is a cross-sectional view of another embodiment of a zipper cover 310a in place over a zipper head 224a. In this embodiment, the insert 326a extends past a second fastening surface 324a pressing the insert against the zipper head 224a. The compressible material of the insert 326 is, enveloping the zipper head 224a and sealing it against the zipper cover.

FIG. 4 illustrates a close up view of the zipper cover of FIGS. 2 and 3, but with the zipper head 222 being slid to a position away from the first end 214 of the zipper track 212. In this figure, a seam cover 408 can be seen running underneath one zipper side 404. The seam cover 408 further seals the zipper track 212 of the bug-resistant mattress cover 200, and, in some embodiments, runs the entire length of the zipper track 212 from the first end 214 to the second end 216. The seam cover 408 is generally fastened to one zipper side 404 allowing the other zipper side 402 to move independently of the seam cover 408. In some embodiments, the seam cover 408 is made of the same material as the cover 200, or any other material that is impermeable to bedbugs. The seam cover 408 serves to further prevent the passage of bedbugs through the teeth of the zipper.

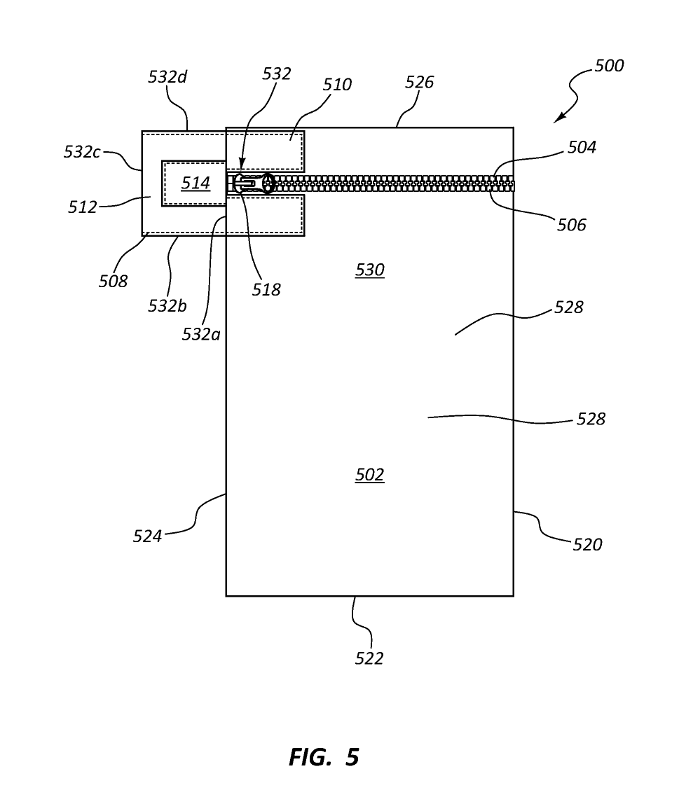

FIG. 5 illustrates an orthogonal view of another embodiment of a bug-resistant furniture cover 500. The embodiment of FIG. 5 is suitable for covering a cushion, such as a pillow. In the embodiment of FIG. 5, a cover 502 is sealed at the edges 520, 522, 524, 526. The interior of the cover 502 forms an interior space 528 for receiving a pillow or cushion. An aperture 504 is located on a side 530 of the cover 502 through which the cushion may pass into the interior space 528 of the cover 502. The cover 502 has a closure mechanism in the form of a zipper track 506 secured proximate the aperture 504. In the embodiment of FIG. 5, the zipper track 506 extends from a first edge 524 edge to a second edge 520 of the cover 502 in a straight line, however, in some embodiments the zipper track 506 may have a non-linear path.

A first fastening surface 510 is located at an end 532 of the zipper track 506. The first fastening surface 510 may be a hook and loop type fastener. A zipper cover 508 is located at the end 532 of the zipper track 506. The zipper cover 508 has a second fastening surface 512 that interfaces with the first fastening surface 510. An insert 514 including a compressible material is disposed within the second fastening surface 512. The zipper cover 508 has have the shape of a square with 4 edges 532a, 532b, 532c, 532d. In other embodiments, the zipper cover 508 has a different shape, such as a trapezoid. One of the edges 532a is attached to the cover 502 proximate the end 532 of the zipper track 506.

An operating mechanism, such as zipper head 518 is disposed along the zipper track 506. To seal the cover 502, the zipper cover 508 is disposed with the first fastening surface 510 and the second fastening surface 512 fastened together with the insert 514 disposed over the zipper head 518. The insert 514 compresses and surrounds the zipper head, creating a bug-resistant seal.

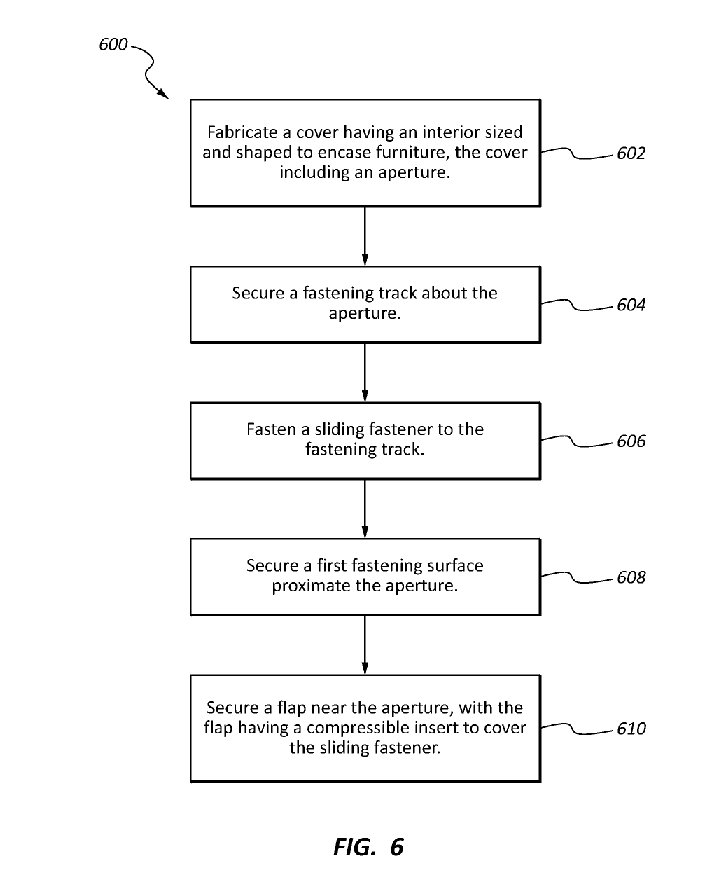

FIG. 6 illustrates an embodiment of a method 600 of making a bug-resistant furniture cover. In the method, a step 602 of fabricating a cover to have an interior size and shape to encase a piece of furniture is performed. The fabric includes an aperture sized and shaped to pass the piece of furniture through the fabric and into the interior of the fabric. In step 604, a fastening track is secured about the aperture. In step 606, a sliding fastener is fastened to the fastening track, such that a movement of the fastener selectively opens and closes the aperture. In some embodiments, the fastening track may be a zipper and the sliding fastener may be a zipper head. In step 608, a first fastening surface is secured to the fabric proximate the aperture and in step 610 a flap is secured to the fabric proximate the aperture. The flap has a second fastening surface and a compressible insert. The flap is positioned to cover the zipper with the compressible insert when the first fastening surface and the second fastening surface are joined such as when the sliding fastener closes the aperture.

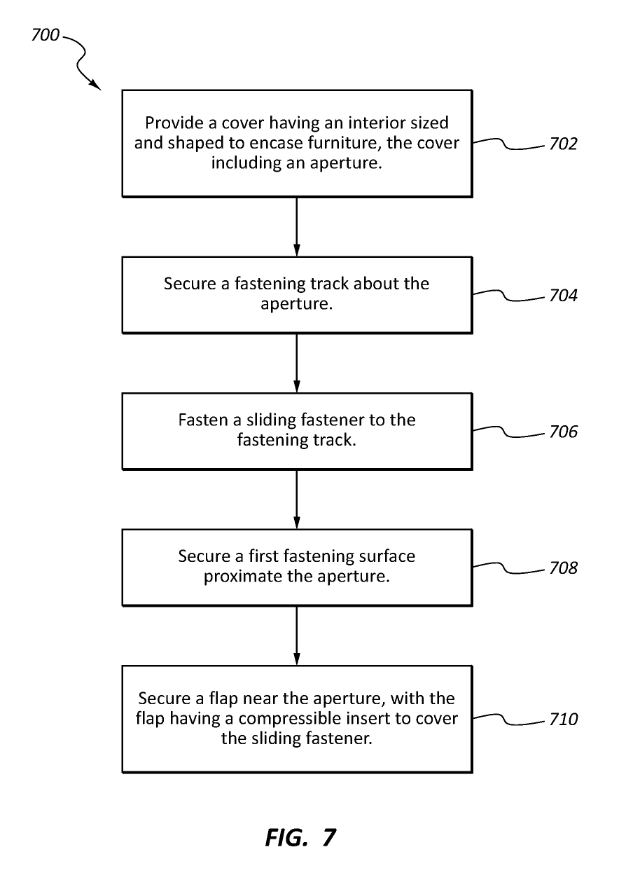

FIG. 7 illustrates an embodiment of a method 700 of making a bug-resistant furniture cover. In the method, a step 702 of providing a cover having an interior size and shape to encase a piece of furniture is performed. The fabric includes an aperture sized and shaped to pass the piece of furniture through the fabric and into the interior of the fabric. In step 704, a fastening track is secured about the aperture. In step 706, a sliding fastener is fastened to the fastening track, such that a movement of the fastener selectively opens and closes the aperture. In some embodiment, the fastening track may be a zipper and the sliding fastener may be a zipper head. In step 708, a first fastening surface is secured to the fabric proximate the aperture and in step 710 a flap is secured to the fabric proximate the aperture. The flap has a second fastening surface and a compressible insert. The flap is positioned to cover the zipper with the compressible insert when the first fastening surface and the second fastening surface are joined such as when the sliding fastener closes the aperture.

In some embodiments, the fastening track has a longitudinal direction with a closed end and an open end and the flap includes an edge. The flap may be secured by stitching the edge at the open end perpendicular to the longitudinal direction. In other embodiments, the edge may be stitched parallel to the longitudinal direction.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A bug-resistant encasement for furniture, comprising:
a cover sized and shaped to encase said furniture, said cover having an exterior surface and an interior surface, said interior surface forming a space for receiving said furniture;
an aperture formed in said fabric cover, said aperture sized and shaped to allow passage of said furniture through said aperture into said space, said aperture having a first edge and a second edge;
a sliding fastener assembly disposed proximate said aperture, said sliding fastener assembly having a closed end and an open end, said sliding fastener assembly including:
a first track proximate said first edge and extending from said closed end to said open end;
a second track proximate said second edge and extending from said closed end to said open end;
a sliding fastener disposed on said first track and said second track and between said closed end and said open end, said sliding fastener configured to mechanically join said first track to said second track between said closed end and said sliding fastener;
a first fastening surface disposed proximate said open end; and
a fastener cover disposed proximate said open end of said sliding fastener assembly, said fastener cover having a second fastening surface and an insert that includes a compressible material.

2. The bug-resistant encasement of claim 1, wherein said sliding fastener is disposed at said closed end and wherein said first fastening surface and said second fastening surface are fastened to each other, such that said fastening cover is positioned over said sliding fastener.

3. The bug-resistant encasement of claim 2, wherein said sliding fastener compresses said compressible material-, thereby forming a seal between said compressible material and said sliding fastener.

4. The bug-resistant encasement of claim 3, wherein said fastening cover has a side fastened to said exterior side, said side fastened perpendicular to said first track and said second track.

5. The bug-resistant encasement of claim 3, wherein said fastening cover has a side fastened to said exterior side, said side fastened parallel to said first track and said second track.

6. The bug-resistant encasement of claim 1, wherein said compressible material is a compressible foam.

7. The bug-resistant encasement of claim 1, wherein said first fastening surface and said second fastening surface are hook and loop type fasteners.

8. The bug-resistant encasement of claim 1, wherein said first track is stitched to said fabric cover proximate said first edge and wherein said second track is stitched to said fabric cover proximate said second edge.

9. A bug-resistant, sliding fastener assembly for use in joining two edges of material, comprising:
a first edge of said material;
a second edge of said material;
an operating mechanism, said operating mechanism having an interior side and an exterior side, said exterior side having a grip for manipulating said operating mechanism;
a closure mechanism having a first side secured to said first edge, a second side secured to said second edge, a first end, and a second end, said closure mechanism being configured to receive said operating mechanism, said operating mechanism slidably engaging said closure mechanism between a first end at which said first edge is coupled to said second edge and a second end at which said first edge is substantially decoupled from said second edge;
a first fastening surface secured to said material and disposed proximate said first end; and
a cover secured to said material proximate said first fastening surface, said cover having a second fastening surface configured to selectively interlock with said first fastening surface, said second fastening surface having an interior portion that includes a compressible material for enveloping said exterior side of said sliding fastener.

10. The bug-resistant, sliding fastener assembly of claim 9, wherein said cover has a first cover edge, wherein said cover is secured to said material along said first cover edge perpendicular to said closure mechanism.

11. The bug-resistant, sliding fastener assembly of claim 9, wherein said cover has a first cover edge, wherein said cover is secured along said first cover edge parallel to said track.

12. The bug-resistant, sliding fastener assembly of claim 9, wherein said compressible material is a flexible foam material.

13. The bug-resistant, sliding fastener assembly of claim 12, wherein said flexible foam material is selected from the group consisting of polyethylene foam, polyurethane foam, and rubber foam.

14. The bug-resistant, sliding fastener assembly of claim 1, wherein said closure mechanism is a zipper.

15. The bug-resistant, sliding fastener assembly of claim 1, wherein said first fastening surface and said second fastening surface are hook and loop fasteners.

16. The bug-resistant, sliding fastener assembly of claim 1, wherein said interior portion of compressible material is surrounded by said second fastening surface.

17. A method for constructing a bug-resistant furniture encasement, the method comprising:
fabricating a material having an interior sized and shaped to encase a piece of furniture, including an aperture sized and shaped to pass said piece of furniture into said interior; securing a fastening track about said aperture;
fastening a sliding fastener to said fastening track such that a movement of the fastener selectively opens and closes said aperture;
securing a first fastening surface proximate said aperture; and
securing a flap proximate said aperture, said flap having a second fastening surface and a compressible insert, said flap being positioned to cover said sliding fastener with said compressible insert when said first fastening surface and said second fastening surface are joined when said sliding fastener closes said aperture.

18. The method of claim 17, wherein said fastening track has a longitudinal direction with a closed end and an open end, and wherein said flap includes an edge, and wherein securing a flap includes stitching said edge at said open end perpendicular to said longitudinal direction.

19. The method of claim 17, wherein said fastening track has a longitudinal direction with a closed end and an open end, and wherein said flap includes an edge, and wherein securing a flap includes stitching said edge at said open end parallel to said longitudinal direction.

20. The method of claim 17, wherein said fastening track is a zipper track and said sliding fastener is a zipper head.
